(19) United States
(12) Patent Application Publication
(10) Pub. No.: US 2014/0169332 A1
(43) Pub. Date: Jun. 19, 2014

(54) METHOD FOR SUPPORTING SELECTION OF PDN CONNECTIONS FOR A MOBILE TERMINAL AND MOBILE TERMINAL

(71) Applicants: Tarik Taleb, Heidelberg (DE); Gottfried Punz, Dossenheim (DE)

(72) Inventors: Tarik Taleb, Heidelberg (DE); Gottfried Punz, Dossenheim (DE)

(73) Assignee: NEC EUROPE LTD, Heidelberg (DE)

(21) Appl. No.: 14/130,951

(22) PCT Filed: Jul. 5, 2012
(86) PCT No.: PCT/EP2012/063176

§ 371 Date: Feb. 6, 2014

(30) Foreign Application Priority Data
Jul. 5, 2011 (EP) 11005470.7

(51) Int. Cl. H04W 36/00

(52) U.S. Cl. CPC H04W 36/0011
USPC 370/331

(57) ABSTRACT

A method for supporting selection of PDN connections for a mobile terminal, in particular in decentralized mobile operator networks, wherein the mobile terminal is connected to an access point, wherein the mobile terminal is in active mode having at least one ongoing IP session to a Packet Data Network (PDN) via a PDN gateway-first PDN gateway-, wherein monitoring whether a more suitable PDN gateway-second PDN gateway-than the first PDN gateway becomes available for the mobile terminal is performed, and wherein in case of detecting the second PDN gateway, any new IP session of the mobile terminal to the PDN is established by initiating a new PDN connection to the second PDN gateway, while an already ongoing session associated with the existing PDN connection to the first PDN gateway is kept. Furthermore, a mobile terminal with PDN connection selection support is disclosed.

The present invention relates to a method for supporting selection of PDN connections for a mobile terminal. Furthermore, the present invention relates to a mobile terminal with PDN connection selection support.

Typically, in mobile networks, a mobility management function decides which gateway shall handle a specific mobile terminal, e.g. a User Equipment (UE) in the terminology of the Evolved Packet System (EPS). For instance, in EPS networks such mobility management function, which is responsible for handover execution decisions, resides in a network component denoted MME (Mobility Management Entity). More specifically, whenever a UE requests connectivity to a PDN (Packet Data Network), the MME selects a PDN gateway for the UE via which the respective PDN connection has to be established.

Currently, mobile networks are highly centralized, not optimized for high-volume data applications that shall come with 4G and beyond technologies. These centralized networks exhibit the following characteristics:
Central gateways handle all mobile IP traffic;
All traffic need to be tunnelled into the core network;
No caching or data offload support at network edge.

This centralized mobile network architecture leads to the following consequences:
High demand on central location due to backhauling of all data traffic;
Dramatic increase in bandwidth requirements and processing load leading to undesirable bottlenecks;
Long communication paths between users and servers leading to waste in Core Network (CN) resources, undesirable delay, and poor QoE (Quality of Experience).

The increase in the number of mobile data users and in particular the rapid traffic increase associated with emerging mobile applications, along with the decrease in the ARPU (Average Revenue per User), are factors that lead mobile operators to utilize traffic offload mechanisms. According to the SA2 (3GPP's System Architecture working group) agreement for SIPTO (Selective IP Traffic Offload) in the macro network, such traffic offload shall be achieved based on local PDN/Serving gateways located close to the RAN (Radio Access Network). This leads essentially to a decentralized mobile network deployment. Mobile operators are therefore showing interest towards decentralizing their networks.

Further, the concept of Access Point Name (APN) has been designed for GPRS and was carried over to UMTS (Universal Mobile Telecommunications System) and EPS (Evolved Packet System) as a scheme to separate logical from physical points of interconnection between a 3GPP operator's IP network and connected-to external PDNs. An APN allows to associate one logical name with a particular type of traffic and maps it flexibly—but constant for the duration of an IP/PDN connection—to a route and point of interconnection. The mapping is done by the network based on DNS (Domain Name System) and the UE may not be aware of it. The UE is not concerned with details of the backend connectivity. This is suitable for the typical, highly centralized network deployments; yet, with new traffic and load scenarios coming into play, especially traffic offload at decentralized points, this is no longer sufficient. The UE, not necessarily the user, may become involved at least partially with network topology for the sake of its optimal backend connectivity, e.g. minimal network resource consumption, cost and/or latency; even with active data transmission over relatively long durations and with larger scale mobility.

Generally, the focus on UEs in ECM (EPS Connection Management) active mode is important due to the fact that most LTE (Long Term Evolution) UEs, e.g. tablets, PCs, even devices similar to currently available 3G smart phones, etc., will be having ongoing background traffic that will make most UEs always actively connected to the network.

In the field of such decentralized mobile networks, to make efficient usage of the network resources, the network needs to provide optimal PDN connectivity for its UEs.

It is therefore an objective of the present invention to improve and further develop a method and a mobile terminal of the initially described type in such a way that, by employing mechanisms that are readily to implement, the support of mobile terminals that are interested in launching new IP sessions to a particular PDN is improved with regard to establishing new optimized PDN connections for the new IP sessions, while at the same time the on-going PDN connections and the corresponding ongoing IP sessions of the mobile terminal to the same PDN are not compromised.

In accordance with the invention, the aforementioned object is accomplished by a method comprising the features of claim 1. According to this claim such a method for supporting selection of PDN connections for a mobile terminal, in particular in decentralized mobile operator networks, is claimed, wherein said mobile terminal is connected to an access point, wherein said mobile terminal is in active mode having at least one ongoing IP session to a Packet Data Network (PDN) via a PDN-gateway-first PDN gateway-, wherein monitoring whether a more suitable PDN gateway-second PDN gateway-than said first PDN gateway becomes available for said mobile terminal is performed, and wherein in case of detecting said second PDN gateway, any new IP session of said mobile terminal to said PDN is established by initiating a new PDN connection to said second PDN gateway, while an already ongoing session associated with the existing PDN connection to said first PDN gateway is kept.

Furthermore, the above mentioned objective is accomplished by a mobile terminal comprising the features of claim 22. According to this claim such a mobile terminal with PDN connection selection support is claimed, wherein said mobile terminal is connected to an access point, wherein said mobile terminal is in active mode having at least one ongoing IP session to a PDN via a PDN gateway-first PDN gateway-, wherein said mobile terminal includes reception means for collecting information whether a more suitable PDN gateway-second PDN gateway-than said first PDN gateway becomes available for said mobile terminal, and wherein said mobile terminal includes decision means for establishing any new IP session to said PDN by initiating a new PDN connection to said second PDN gateway in case of detecting said second PDN gateway, while keeping an already ongoing IP session associated with the existing PDN connection to said first PDN gateway.

According to the present invention it has first been recognized that basically there is a need for mobile terminals to launch multiple IP sessions to the same PDN. Furthermore, it has been recognized that using an existing PDN connection to the PDN in question for new IP sessions might be disadvantageous in several aspects. As a solution the present invention proposes the following mechanism: When for a mobile terminal that accesses a particular PDN using a given PDN connection, a more optimized/suitable PDN gateway becomes available, the mobile terminal shall set up a new PDN connection to the more optimized PDN gateway when the UE wants to initiate a new IP session to the same PDN.

Consequently, the present invention devises a mechanism that enables a mobile terminal to establish another optimized PDN connection to the same PDN. Thus, in case of detecting the second PDN gateway, any new IP session of the mobile terminal to the PDN is established by initiating a new PDN connection to the second PDN gateway, while an already ongoing IP session associated with the existing PDN connection to the first PDN gateway is kept.

As a matter of course, at the same time more than one PDN gateway that is more optimized/suitable than the first PDN gateway, i.e. the one being currently employed, may become available. Insofar, the term “second PDN gateway” is understood to possibly include a plurality of PDN gateways (e.g. a third, fourth, etc. PDN gateway), from which then e.g. the most optimized/suitable PDN gateway can be chosen. For instance, if the mobile terminal continues moving, it may always take the most optimal PDN gateway for new IP sessions, while the old IP sessions are kept on the PDN gateway where they were initially established.

Applying the method according to the present invention, i.e. adding “suitable” PDN connections for mobile terminals during active mobility that are used for new IP flows while maintaining the ongoing PDN connections, enables mobile terminals to always have optimized PDN connections. Typical scenarios in which the invention can be advantageously applied include for instance the scenario of a mobile terminal that travels a long-distance while keeping a long-lived IP session or, even more likely to occur, a scenario in the context of SIPTO (Selected IP Traffic Offload), if a nearby and less loaded PDN gateway becomes available. In any case, as a result the present invention has important benefits for the operator, in particular with respect to efficient load balancing, data traffic route optimization, service localization, efficient support of SIPTO (Selected IP Traffic Offload), savings in overall network resources, etc. However, it is to be noted that the present invention considers only mobile terminals that support multiple simultaneous PDN connections to the same PDN.

With respect to an efficient and consistent determination of the degree of suitability of a PDN gateway it may be provided that certain parameters related to specific characteristics of the PDN gateway are taken into consideration. In particular, the degree of a suitability of a PDN gateway may be determined in terms of, but not limited to, its capabilities, its load, its geographical proximity relative to the mobile terminal, and/or its suitability for handling the packets of the service or application type to be launched via a new IP session to be initiated by the mobile terminal. In this context it may be provided that a plurality of different parameters is considered and weighted according to predefined policies, which may be specified by the network operator. For instance, a PDN gateway having only little load may be regarded more suitable than a rather heavy loaded PDN gateway, although its distance to the mobile terminal might be longer.

Generally, it may be provided that the monitoring and/or detecting of the availability of more suitable PDN gateways is/are performed by a network node including but not limited to a Mobility Management Entity, in accordance with the respective EPS notation briefly denoted MME hereinafter. Additionally or alternatively, the network node may include a Serving GPRS Support Node (SGSN), an ANDSF or another node with a subset of MME functions. The MME may apply different mechanisms to check whether there are any more suitable PDN gateways available for a specific mobile terminal. In this context it is assumed that the MME has specific gateway selection mechanisms. Further, it is assumed that the MME has prior knowledge on information related to PDN gateways (e.g. load) in real time.

As mentioned already above, it is considered a scenario of a mobile terminal in ECM-active mode having an IP session or multiple IP sessions to a given PDN.

After the optimality of the currently used PDN gateway is lost, e.g. due to movement of the mobile terminal, load change, etc., the mobile terminal wants to initiate a new IP session to the same PDN. When a better, i.e. more optimal PDN gateway becomes available, a mobile terminal needs to become aware of this fact.

In case the MME figured out that one or more PDN gateways are available, namely the second PDN gateway, which are/is more suitable than the PDN gateway currently employed by the mobile terminal, MME may indicate this to the mobile terminal, preferably by using NAS (Non-Access Stratum) signaling. Generally, the mobile terminal needs to know only about the optimality of the currently serving PDN gateway.

According to a preferred embodiment the indication may include a flag. Furthermore, the indication may include an APN referring to the second PDN gateway. Thus the APN can function as reference to the second PDN gateway, i.e. the APN is linked to the second gateway.

According to a further preferred embodiment, it may be provided that a change of a Serving gateway, a SGSN and/or any network node with mobility anchoring capability within an existing handover procedure is employed as a trigger for the mobile terminal in order to become aware of the availability of the second PDN gateway.

Advantageously, it may be provided that in case a Serving gateway or any network node with mobility anchoring capability changes as part of a TAU (Tracking Area

Update) procedure, which in turn occurs within an X2- or S1-based handover procedure, the indication is included in a TAU Accept message to the mobile terminal. Thus, the MME can for instance send a corresponding flag in the TAU accept message to the mobile terminal.

With respect to becoming aware of the availability of a better, i.e. more optimal/suitable PDN gateway, it may be provided that a MME change within an existing handover procedure may be employed as a trigger for the mobile terminal in order to become aware of the availability of the second PDN gateway.

According to a preferred embodiment a mobile network operator may map APNs to predefined geographical locations in order to provide localized APNs, for instance by mapping APNs to PDN gateways. An APN defines the point of interconnection with the PDN.

These geographical locations may be Serving gateway service areas, MME pool areas, geographical locations of PDN gateways, etc. and the corresponding localized APNs may look like, e.g., APN1=″internet@location1″, APN2=″internet@location2″, etc. It is noted that this is somehow against the original principle of APN, namely to achieve location independence of access to a PDN. However, in the light of the trend towards decentralized mobile operator networks, localization of APNs is also required.

Advantageously, it may be provided that the mobile terminal requests PDN connectivity in order to initiate the new PDN connection by sending a signaling message, in particular a PDN connectivity request, to the MME, wherein the signaling message includes information indicating the request for selecting the second PDN gateway for the mobile terminal.

According to a preferred embodiment the information may include an old APN that is already being employed for the existing PDN connection and a predefined flag. Thus, when the mobile terminal wants to initiate a new IP session to the PDN, the mobile terminal may issue a “PDN connectivity request” to MME. It is noted that a PDN connectivity request message includes the fields APN, PDN Type, Protocol Configuration Options and Request Type. The Request Type indicates “initial request” if the mobile terminal requests new additional PDN connectivity over the 3GPP access network for multiple PDN connections. Being aware of the availability of an optimal/suitable PDN gateway, the mobile terminal can insert in the PDN connectivity request the old/same APN and the flag. The MME employs the flag as an indication to select for the mobile terminal the currently optimal PDN gateway, i.e. the second PDN gateway. This proposed solution can be of use in case an operator does not consider localized APNs per geographical locations.

According to another preferred embodiment the information may include an old APN that is already being employed for the existing PDN connection and a predefined Request Type value. The Request Type value may be set to a predefined value, e.g. “optimized initial request”. Thus, the MME may use the Request Type value as indication to select for the mobile terminal the currently optimal PDN gateway, i.e. the second PDN gateway. This proposed solution can also be of use in case an operator does not consider localized APNs per geographical locations.

According to another preferred embodiment the information may include an APN referring to the second PDN gateway, wherein the mobile terminal has received the APN from the MME.

According to another preferred embodiment the information may include an APN referring to the second PDN gateway, wherein the mobile terminal being configured with a list including localized APNs employs the list for deriving the APN which corresponds to the current location of the mobile terminal.

According to another preferred embodiment the information may include an APN referring to the second PDN gateway, wherein the mobile terminal has requested the APN from a configuration server, e.g. an ANDSF (Access Network Discovery and Selection Function), DNS, etc., that provides localized APNs.

Advantageously, the configuration server may recommend the APN dependent on the current location of the mobile terminal.

Advantageously, upon establishing the new PDN connection to the second PDN gateway, the mobile terminal may store the APN being employed for the new PDN connection into its information storage. Additionally, the mobile terminal may map the corresponding established IP sessions to the new PDN connection and to the APN.

Advantageously, it may be provided that when the established IP sessions being delivered on the top of the existing PDN connection are all off, e.g. in case the time in point of the last received/transmitted packet on the PDN connection is older than a certain threshold, the corresponding APNs are deleted from the information storage of the mobile terminal.

With respect to a network based approach, it may be provided that in case the MME detects the availability of the second PDN gateway for the mobile terminal during a TAU procedure of the mobile terminal, the MME performs all necessary for the setup of PDN connectivity to the second PDN gateway, in particular by re-using the information received for the already existing PDN connection with the first PDN gateway. Subsequently, the MME instructs the mobile terminal, preferably by using NAS (Non-Access Stratum) signaling, conveying the same APN that is already employed for the existing PDN connection and new PDN address information of the mobile terminal.

According to a preferred embodiment, it may be provided that resource handling is done on the basis of separated treatment of said PDN connections and/or said APNs. Thus, bit rates for a newly established PDN connection are independent from bit rates for the already existing one, although logically linked to or derived from the existing one. Other QoS parameters may be copied, for example QCI (Quality Class Identifier) and/or ARP (Allocation and Retention Priority).

It is noted that the present invention not only addresses specifically EPS, the present invention applies also to any PS-domain of similar type mobile network including GPRS/UMTS and CDMA2000.

Similarly, the present invention applies to mobile networks whereby:
MME maps onto Serving GPRS Support Node (SGSN) or any other network node with mobility management functions,
Serving Gateway maps onto SGSN or any network node with mobility anchoring functions,
PDN Gateways maps onto Gateway GPRS Support Node (GGSN) or any network node with data anchoring functions,
TAU maps onto Location Area Update (LAU), Routing Area Update (RAU) or any generic mobility management procedure for UEs in active mode, and/or
NAS maps onto any generic mobility management protocol.

There are several ways how to design and further develop the teaching of the present invention in an advantageous way. To this end it is to be referred to the patent claims subordinate to patent claims 1 and 22 on the one hand and to the following explanation of preferred embodiments of the invention by way of example, illustrated by the drawing on the other hand. In connection with the explanation of the preferred embodiments of the invention by the aid of the drawing, generally preferred embodiments and further developments of the teaching will be explained. In the drawing

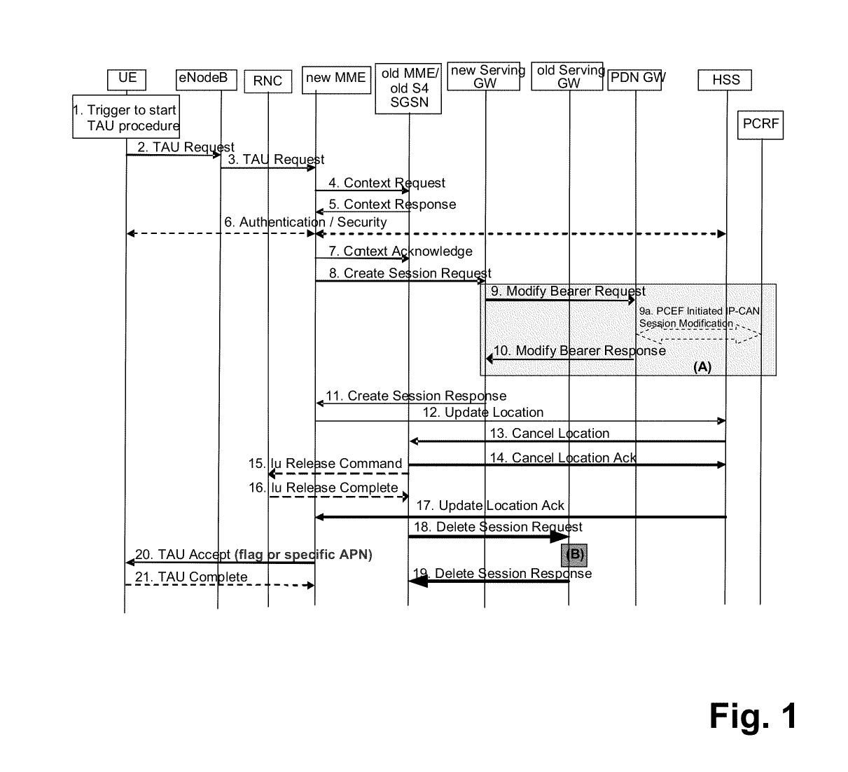

FIG. 1 is a diagram showing a TAU procedure with Serving gateway change according to an embodiment of the present invention,

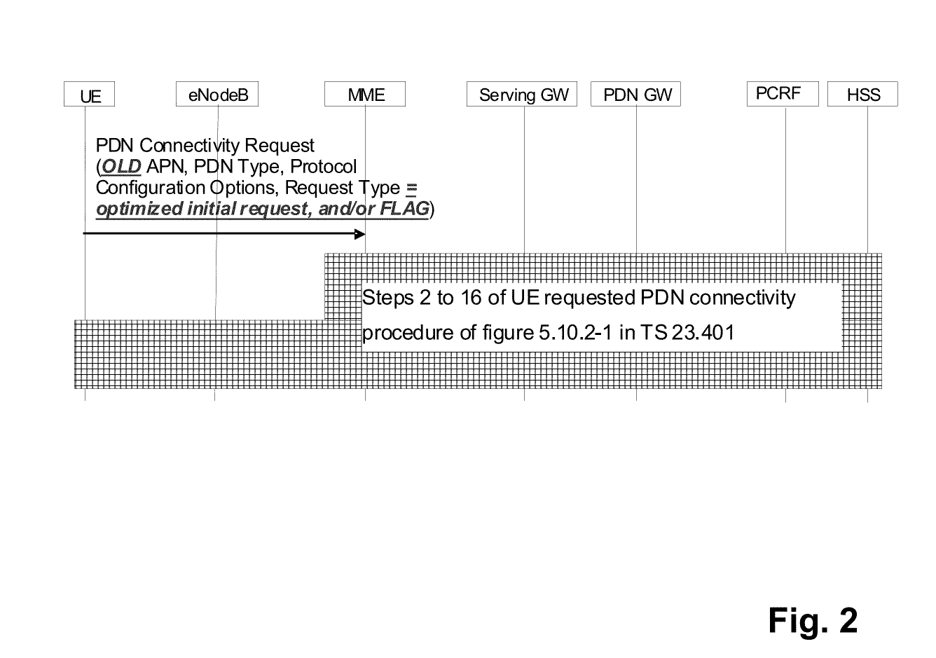

FIG. 2 is a diagram showing a UE requested PDN connectivity procedure according to another embodiment of the present invention,

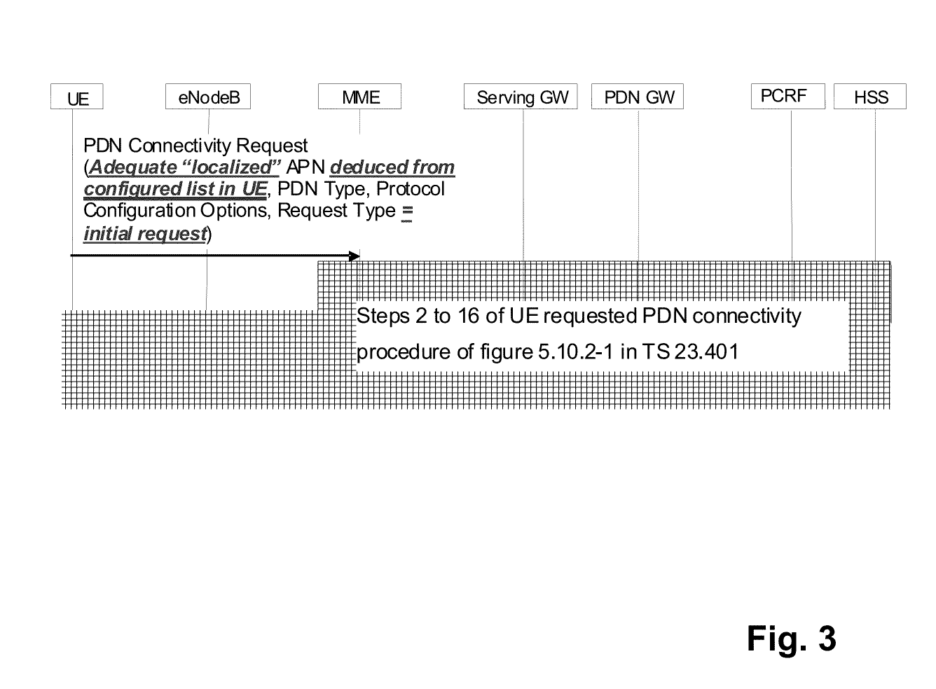

FIG. 3 is a diagram showing a UE requested PDN connectivity procedure according to another embodiment of the present invention,

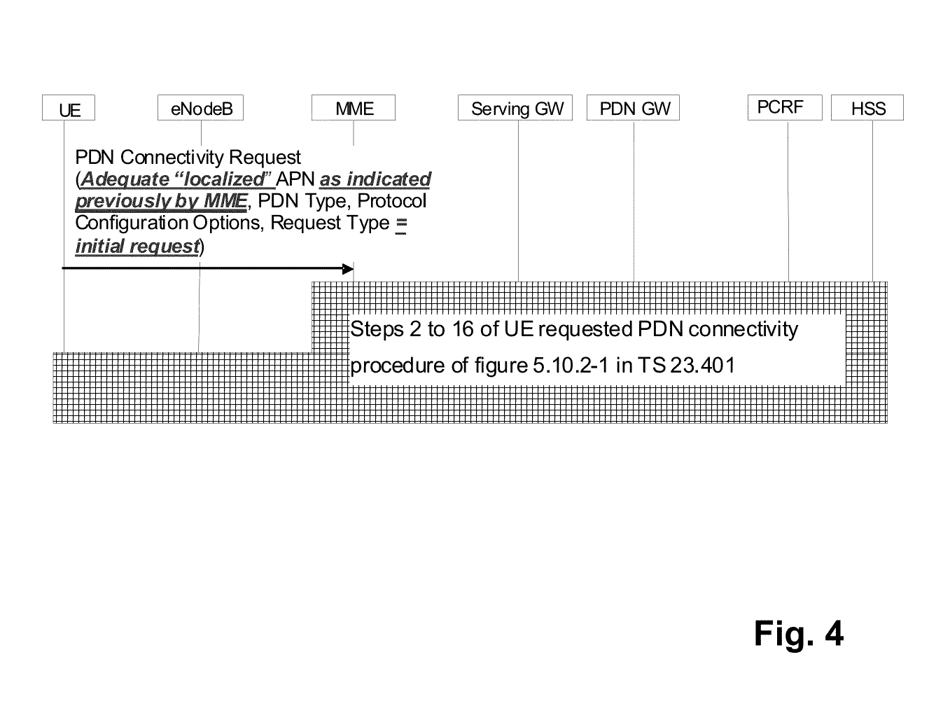

FIG. 4 is a diagram showing a UE requested PDN connectivity procedure according to another embodiment of the present invention,

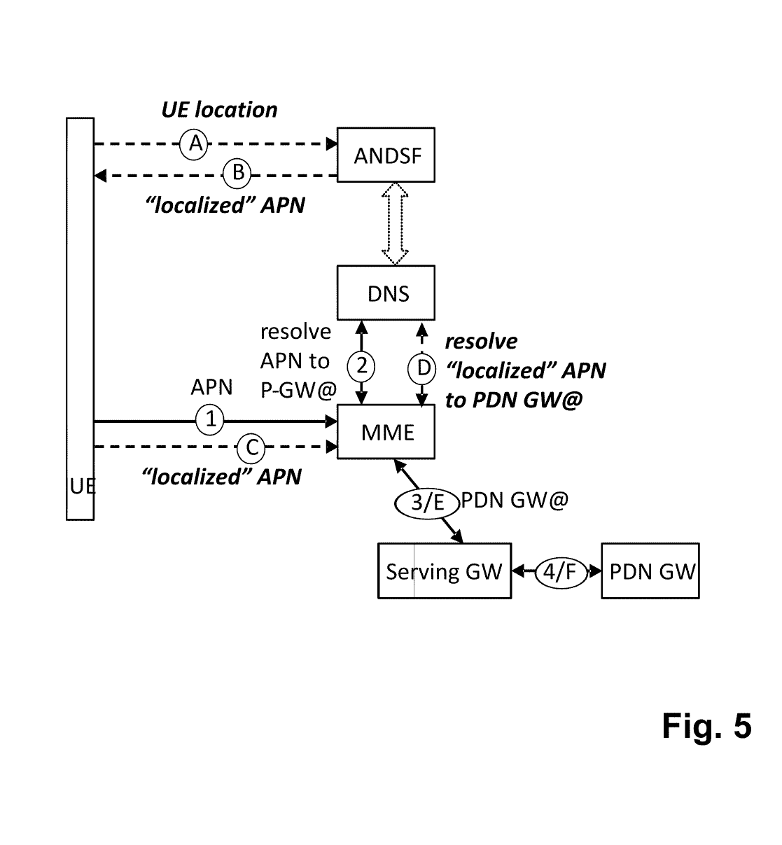

FIG. 5 is a schematic view illustrating an APN resolution mechanism according to another embodiment of the present invention,

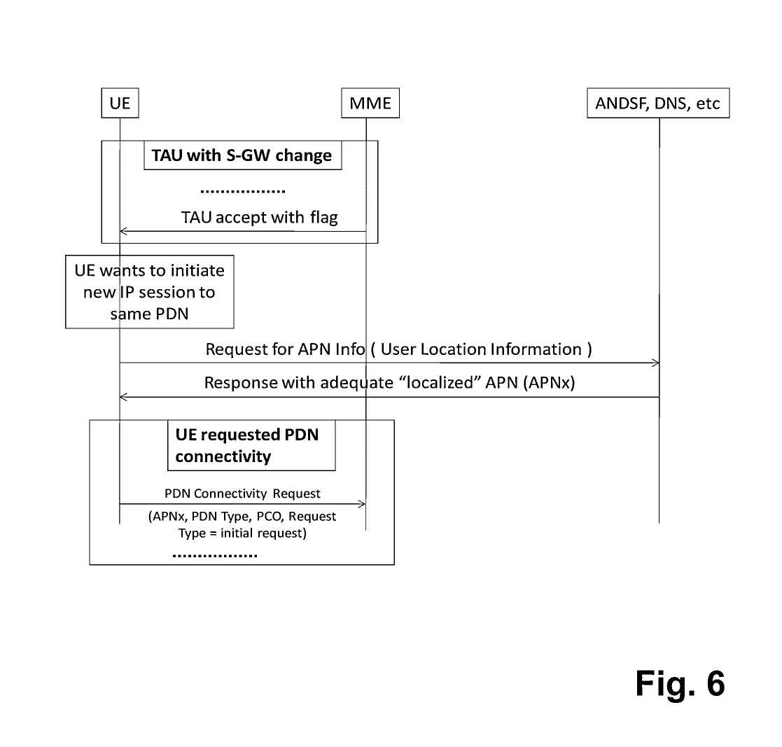

FIG. 6 is a schematic view illustrating an application scenario of a method according to the present invention employing the APN resolution mechanism according to FIG. 5, and

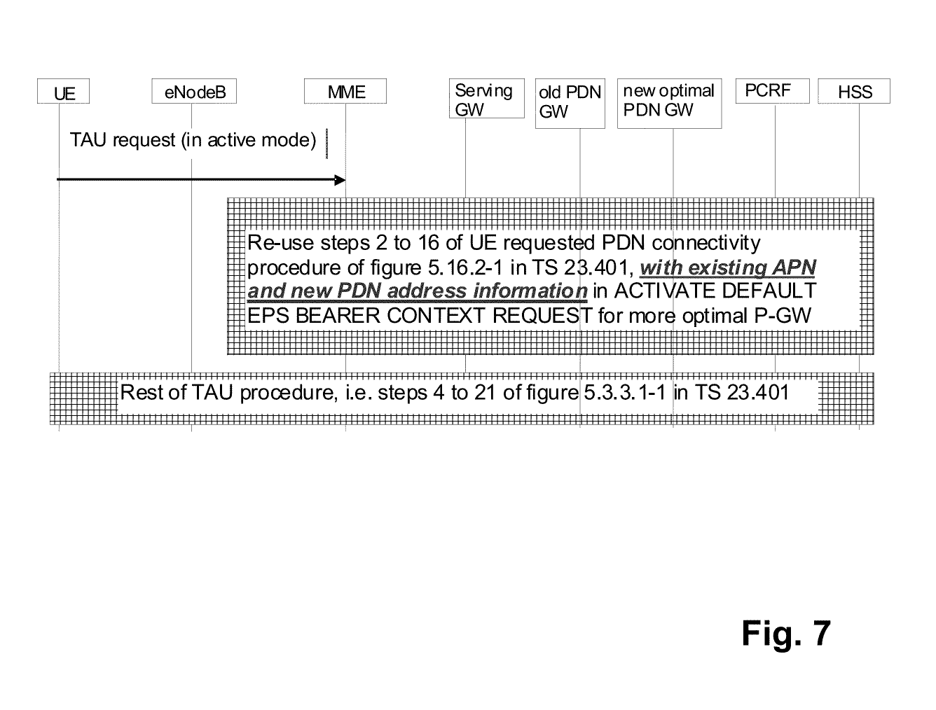

FIG. 7 is a diagram showing a network based additional PDN connectivity setup according to another embodiment of the present invention.

FIG. 1 shows a diagram illustrating a Tracking Area Update (TAU) procedure with a Serving gateway change according to an embodiment of the present invention.

It is considered a scenario of a UE in ECM-active mode having an IP session or multiple IP sessions to a given PDN. After the optimality of the currently used PDN gateway (PDN GW) is lost, e.g. due to movement of the UE, load change, etc., the UE wants to initiate a new IP session to the same PDN.

When a more suitable, i.e. more optimal, PDN GW becomes available, the UE needs to become aware of this fact. Thus, a trigger is required. Therefore the UE may use the Serving gateway (Serving GW) change or MME change within existing handover procedures as a trigger. It is noted that Serving GW change and MME change could potentially indicate a change in the Serving GW service area and MME pool area, respectively. In case of Serving GW change for the cause of load balancing, this change shall indicate that the current Serving GW is no longer optimal, and that another better Serving GW becomes available. Additionally, and especially in a distributed mobile operator network where Serving GWs could be potentially collocated with PDN GWs, a change in Serving GW can be an indication that a change of the PDN GW may be desired; even in case of non-collocation of Serving GW and PDN GW the same indication about non-optimality of current PDN GW can be utilized.

It is noted that a UE is aware of an MME change, but not of a Serving GW change. Knowing MME change does not necessarily make a UE aware of the distributed network topology; the same can be said about when the UE becomes aware of a Serving GW change. However, the UE needs to know only about the optimality of the currently serving PDN GW in comparison to others that are in the geographical vicinity of the UE, not the distributed network topology in full.

Whilst MME change is noticed by the UE, as it holds relevant context at its information storage according to Table 5.7.5-1 of 3GPP TS 23.401v10.4.0, “General Packet Radio Service (GPRS) enhancements for Evolved Universal Terrestrial Radio Access Network (E-UTRAN) access” (2011-06-12), with the current standards, a Serving GW change cannot be noticed by the UE.

Therefore, it is proposed according to the embodiment of FIG. 1 that when the

Serving GW changes as part of a TAU procedure, which in turn occurs within an X2- or S1-based handover procedure, the MME sends a corresponding flag in the TAU accept message according to procedure 5.3.3.1 of TS 23.401 to the UE. The UE interprets this flag as an indication that the current PDN GW may no longer be optimal and that another optimal/more suitable PDN GW may have become available.

Alternatively, the MME sends the optimal APN—specific APN—in the TAU accept message according to procedure 5.3.3.1 of TS 23.401 to the UE. Thus, the UE can employ the specific APN to request for PDN connectivity whenever the UE desires to initiate a new IP session to the same PDN as described in subclause 5.10.2 of TS 23.401.

When the UE wants to initiate a new IP session to the same PDN, it needs to know/decide how to route the traffic of that IP session. Based on the indication from the MME that the Serving GW has changed or based on a MME change, the UE carries out the UE requested PDN connectivity procedure as in subclause 5.10.2 of TS 23.401. The MME uses the PDN GW selection function according to subclause 4.3.8.1 of TS 23.401 to select the optimal PDN GW for the UE to connect to the same PDN. After the setup of the new PDN connection, the UE stores the relevant APN into its information storage and maps it to the relevant PDN connection and IP sessions/flows.

FIG. 2 is a diagram showing a UE requested PDN connectivity procedure according to another embodiment of the present invention. A UE requests PDN connectivity with an optimization flag and the old/same APN being already used for the existing PDN connection.

According to the example illustrated in FIG. 1, the MME sends a flag to the UE in the TAU accept message. Subsequently, when the UE wants to initiate a new IP session to the PDN, it issues a PDN connectivity request to the MME that is illustrated in FIG. 2. The PDN connectivity request message contains the fields APN, PDN Type, Protocol Configuration Options and Request Type. The Request Type indicates “initial request” if the UE requests new additional PDN connectivity over the 3GPP access network for multiple PDN connections. Being aware of the availability of an optimal PDN GW, the UE indicates in the PDN connectivity request the old/same APN and a flag or sets the Request Type to a predetermined value, e.g. “optimized initial request”. The MME uses the flag or the Request Type value as an indication to select for the UE the currently optimal P-GW, i.e. the second PDN gateway. Upon the PDN connectivity request message, the steps 2 to 16 of the UE requested PDN connectivity procedure according to FIG. 5.10.2-1 of TS 23.401 are performed. This solution can be of use in case an operator does not consider localized APNs per geographical locations. Modified information elements according to the embodiment of the present invention of FIG. 2 are marked in bold, italic and underlined in FIG. 2.

FIG. 3 is a diagram showing a UE requested PDN connectivity procedure according to another embodiment of the present invention. A UE requests PDN connectivity with Request type “initial request” and a localized APN which is deduced from a configured list in the UE.

The MME sends a flag to the UE. The UE is configured with a list of APNs that are mapped to geographical locations. From its current location, the UE deduces the right APN and issues a PDN connectivity request to MME and inserts the adequate APN according to FIG. 3. Upon the PDN connectivity request message, the steps 2 to 16 of the UE requested PDN connectivity procedure according to FIG. 5.10.2-1 of TS 23.401 are performed. Modified information elements according to the embodiment of the present invention of FIG. 3 are marked in bold, italic and underlined in FIG. 3.

FIG. 4 is a diagram showing a UE requested PDN connectivity procedure according to another embodiment of the present invention. A UE requests PDN connectivity with Request type “initial request” and a localized APN as indicated previously by the MME.

In the TAU accept message, the MME inserts the currently optimal localized APN to the UE. When the UE wants to initiate a new IP session to the same PDN, it carries out the UE-requested PDN connectivity as in subclause 5.10.2 of TS 23.401 and indicates the optimal localized APN in the PDN Connectivity Request that is illustrated in FIG. 4. Modified information elements according to the embodiment of the present invention of FIG. 4 are marked in bold, italic and underlined in FIG. 4.

FIG. 5 is a schematic view illustrating an APN resolution mechanism according to another embodiment of the present invention and the existing resolution mechanism according to the prior art.

The existing APN resolution mechanism according to the prior art is outlined in FIG. 5 with full lines and steps numbered from 1 to 4.

The new APN resolution mechanism according to an embodiment of the present invention is outlined in FIG. 5 with steps numbered from A to F. This embodiment assumes ANDSF acquiring localized APN information. The advantage is that existing NAS signaling can be kept unchanged; only the ANDSF information element is used differently.

It is noted that in OPIIS WID item description, 3GPP document SP-110222 ANDSF will be providing UEs with policies on what PDN connection to select.

Based on the indication from the MME that the Serving GW has changed or based on the MME change notification, the UE consults ANDSF or DNS or any other network node with defined policies. ANDSF or an alike node is assumed to maintain a table that maps APNs for each location. Upon receiving the current location of the UE from the UE—step A of FIG. 5—, ANDSF or an alike node provides the UE with policies containing a suitably mapped APNx—step B of FIG. 5—, based on which UE establishes new IP sessions to the same PDN via a new optimal PDN GW, using the relevant APNx indicated by the ANDSF. Using this indicated APNx, the UE issues a PDN connectivity request to the MME as in subclause 5.10.2 of TS 23.401. The MME uses the PDN GW selection function according to subclause 4.3.8.1 of TS 23.401 to select the optimal PDN GW for the UE to connect to the same PDN. After the setup of the new PDN connection, the

UE stores the relevant APNx into its information storage and maps the relevant IP flows to the relevant PDN connection and APNx. The added signaling steps between UE and ANDSF and the different use of APN, namely as a “localized” APN is shown in FIG. 5, with steps numbered from A to F. The steps C to F are identical to steps 1 to 4 of the existing procedure.

How the APN resolution mechanism of FIG. 5 is embedded in the above described TAU procedure with a S-GW change is illustrated in FIG. 6. It is also assumed that ANDSF has its configuration data aligned with the DNS data, this is indicated by the double arrow between the two entities UE and ANDSF of FIG. 6.

FIG. 7 is a diagram showing a network based additional PDN connectivity setup according to another embodiment of the present invention. This embodiment of the present invention avoids informing the UE beforehand about the change in optimality of the selected PDN GW for a particular PDN. Instead, if the MME detects the change in optimality of the PDN GW during a TAU procedure of a UE in active mode, it performs all necessary setup of PDN connectivity to this more suitable PDN GW, re-using the information received for the already existing PDN connection with the previous old PDN GW. Subsequently it instructs the UE directly with the NAS message ACTIVATE DEFAULT EPS BEARER CONTEXT REQUEST according to FIG. 6.4.1.2.1 and message contents in table 8.3.6.1 of 3GPP TS 24.301v10.3.0 “Non-Access-Stratum (NAS) protocol for Evolved Packet System (EPS); Stage 3” (2011-06-15), conveying the same APN as already used for the existing connection and with corresponding new IP address information of the UE, i.e. the PDN address information.

It is noted that this means a change in the concept of the state model in the UE and the MME; generally this message is sent in response to a PDN CONNECTIVITY REQUEST message from UE to the network. The UE responds generally to ACTIVATE DEFAULT EPS BEARER CONTEXT REQUEST, after which the network completes the TAU signaling sequence.

Many modifications and other embodiments of the invention set forth herein will come to mind the one skilled in the art to which the invention pertains having the benefit of the teachings presented in the foregoing description and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

1. Method for supporting selection of PDN connections for a mobile terminal, in particular in decentralized mobile operator networks,
wherein said mobile terminal is connected to an access point,
wherein said mobile terminal is in active mode having at least one ongoing IP session to a Packet Data Network (PDN) via a PDN gateway-first PDN gateway-,
wherein monitoring whether a more suitable PDN gateway-second PDN gateway-than said first PDN gateway becomes available for said mobile terminal is performed, and
wherein in case of detecting said second PDN gateway, any new IP session of said mobile terminal to said PDN is established by initiating a new PDN connection to said second PDN gateway, while an already ongoing session associated with the existing PDN connection to said first PDN gateway is kept.

2. Method according to claim 1, wherein the degree of suitability of a PDN gateway is determined in terms of its capabilities, its load, geographical proximity relative to said mobile terminal and/or its suitability for handling the packets of the service or application type to be launched via said new IP session.

3. Method according to claim 1, wherein said monitoring and/or detecting of the availability of more suitable PDN gateways is/are performed by a Mobility Management Entity (MME).

4. Method according to claim 1, wherein said Mobility Management Entity (MME) notifies said mobile terminal, preferably by using NAS (Non-Access Stratum) signaling, that said second PDN gateway enabling a better PDN connectivity for said mobile terminal is available.

5. Method according to claim 4, wherein said indication includes a flag and/or an APN referring to said second PDN gateway.

6. Method according to claim 1, wherein a change of a Serving gateway within a handover procedure is employed as a trigger for said mobile terminal in order to become aware of the availability of said second PDN gateway.

7. Method according to claim 1, wherein in case a Serving gateway changes as part of a TAU procedure, said indication is included in a TAU Accept message to said mobile terminal.

8. Method according to claim 1, wherein a MME change within a handover procedure is employed as a trigger for said mobile terminal in order to become aware of the availability of said second PDN gateway.

9. Method according to claim 1, wherein APNs are mapped to predefined geographical locations in order to provide localized APNs, in particular by mapping said APNs to PDN gateways.

10. Method according to claim 9, wherein said geographical locations are Serving gateway service areas, Mobility Management Entity (MME) pool areas and/or geographical locations of PDN gateways.

11. Method according to claim 1, wherein said mobile terminal requests PDN connectivity in order to initiate said new PDN connection by sending a signaling message, in particular a PDN connectivity request, to the Mobility Management Entity (MME), wherein said signaling message includes information indicating the request for selecting said second PDN gateway for said mobile terminal.

12. Method according to claim 11, wherein said information includes an old APN that is already being employed for said existing PDN connection and a predefined flag.

13. Method according to claim 11, wherein said information includes an old APN that is already being employed for said existing PDN connection and a predefined Request Type value.

14. Method according to claim 11, wherein said information includes an APN referring to said second PDN gateway, wherein said mobile terminal has received said APN from the Mobility Management Entity (MME).

15. Method according to claim 11, wherein said information includes an APN referring to said second PDN gateway, wherein said mobile terminal being configured with a list including localized APNs employs said list for deriving said APN that corresponds to the current location of said mobile terminal.

16. Method according to claim 11, wherein said information includes an APN referring to said second PDN gateway, wherein said mobile terminal has requested said APN from a configuration server, in particular a ANDSF, DNS, etc., that provides localized APNs.

17. Method according to claim 16, wherein said configuration server recommends said APN dependent on the current location of said mobile terminal.

18. Method according to claim 1, wherein upon establishing said new PDN connection to said second PDN gateway, said mobile terminal stores said APN being employed for said new PDN connection into its information storage, and wherein said mobile terminal maps the corresponding established IP sessions to said new PDN connection and said APN.

19. Method according to claim 1, wherein in case said established IP session being delivered on the top of said existing PDN connection are off, in particular in case the time in point of the last received/transmitted packet on the PDN connection is older than a certain threshold, said corresponding APNs are deleted from the information storage of said mobile terminal.

20. Method according to claim 1, wherein in case said Mobility Management Entity (MME) detects the availability of said second PDN gateway for said mobile terminal during a TAU procedure of said mobile terminal, said Mobility Management Entity (MME) performs the setup of PDN connectivity to said second PDN gateway, in particular by re-using the information received for said already existing PDN connection with said first PDN gateway, and wherein subsequently said Mobility Management Entity (MME) instructs said mobile terminal, preferably by using NAS (Non-Access Stratum) signaling, by conveying same APN that is already employed for said existing PDN connection and new PDN address information of said mobile terminal.

21. Method according to claim 1, wherein resource handling is done on the basis of separated treatment of said PDN connections and/or said APNs.

22. Mobile terminal with PDN connection selection support, in particular for executing a method according to claim 1,
wherein said mobile terminal is connected to an access point,
wherein said mobile terminal is in active mode having at least one ongoing IP session to a PDN via a PDN gateway-first PDN gateway-,
wherein said mobile terminal includes reception means for collecting information whether a more suitable PDN gateway-second PDN gateway-than said first PDN gateway becomes available for said mobile terminal, and
wherein said mobile terminal includes decision means for establishing any new IP session to said PDN by initiating a new PDN connection to said second PDN gateway in case of detecting said second PDN gateway, while keeping an already ongoing IP session associated with the existing PDN connection to said first PDN gateway.
